(19) United States
(12) Patent Application Publication
(10) Pub. No.: US 2025/0288952 A1
(43) Pub. Date: Sep. 18, 2025

(54) ELECTROCHEMICAL CELL AND CARBON DIOXIDE RECOVERY SYSTEM

(71) Applicant: DENSO CORPORATION, Kariya-city (JP)

(72) Inventors: HIROSHI OKAMOTO, Kariya-city (JP); SHIGEKI NAKAO, Kariya-city (JP); JUNICHI NARUSE, Kariya-city (JP)

(21) Appl. No.: 19/053,561

(22) Filed: Feb. 14, 2025

(30) Foreign Application Priority Data
Mar. 14, 2024 (JP) 2024-040287
Nov. 21, 2024 (JP) 2024-203398

(51) Int. Cl. B01D 53/32; B01D 53/04

(52) U.S. Cl. CPC B01D 53/326; B01D 53/04; B01D 2253/1122; B01D 2253/1124; B01D 2253/25; B01D 2257/504

(57) ABSTRACT

An electrochemical cell includes a working electrode and a counter electrode, and the working electrode includes a CO₂ adsorbent. The electrochemical cell is configured such that, when a voltage is applied between the working electrode and the counter electrode, electrons are supplied from the counter electrode to the working electrode, and the CO₂ adsorbent bonds with CO₂ contained in a CO containing gas in association with the electrons being supplied to the working electrode. The CO₂ adsorbent contains a transition metal oxide represented by a general formula MₓO_{y}, where M is a transition metal, x is within a range of 1≤x≤3, and y is within a range of 1≤y≤5, excluding a combination of x=1 and y=2.

### CROSS REFERENCE TO RELATED APPLICATIONS

The present application claims the benefit of priority from Japanese Patent Application No. 2024-040287 filed on Mar. 14, 2024 and Japanese Patent Application No. 2024-203398 filed on Nov. 21, 2024. The entire disclosures of the above applications are incorporated herein by reference.

### TECHNICAL FIELD

The present disclosure relates to an electrochemical cell and a carbon dioxide recovery system.

### BACKGROUND

Conventionally, electrochemical cells that adsorb and desorb carbon dioxide (hereinafter, also referred to as CO₂) from a mixed gas that contains CO₂ by electrochemical reactions are known. For example, an electrochemical cell using polyanthraquinone as a CO₂ adsorbent that adsorbs and desorbs CO₂ is known.

### SUMMARY

The present disclosure provides an electrochemical cell that includes a working electrode and a counter electrode, and the working electrode includes a CO₂ adsorbent. The electrochemical cell is configured such that, when a voltage is applied between the working electrode and the counter electrode, electrons are supplied from the counter electrode to the working electrode, and the CO₂ adsorbent bonds with CO₂ contained in a CO containing gas in association with the electrons being supplied to the working electrode. The CO₂ adsorbent contains a transition metal oxide represented by a general formula MₓO_{y}, where M is a transition metal, x is within a range of 1≤x≤3, and y is within a range of 1≤y≤5, excluding a combination of x=1 and y=2.

The present disclosure also provides a carbon dioxide recovery system for separating CO₂ from a CO₂ containing gas by electrochemical reactions, and the carbon dioxide recovery system includes an electrochemical cell. The electrochemical cell includes a working electrode and a counter electrode, and the working electrode includes a CO₂ adsorbent. The CO₂ adsorbent contains a transition metal oxide represented by a general formula MₓO_{y}, where M is a transition metal, x is in a range of 1≤x≤3, and y is in a range of 1≤y≤5, excluding a combination of x=1 and y=2. The electrochemical cell is configured such that, when a first voltage is applied between the working electrode and the counter electrode, electrons are supplied from the counter electrode to the working electrode, causing the CO₂ adsorbent to adsorb CO₂ contained in the CO₂ containing gas, and, when a second voltage is applied between the working electrode and the counter electrode, electrons are supplied from the working electrode to the counter electrode, causing CO₂ to be desorbed from the CO₂ adsorbent.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system according to one embodiment;

FIG. 2 illustrates a carbon dioxide recovery device according to the one embodiment;

FIG. 3A is a diagram for explaining the operation of the carbon dioxide recovery device in a CO₂ recovery mode;

FIG. 3B is a diagram for explaining the operation of the carbon dioxide recovery device in a CO₂ discharge mode;

FIG. 4 is a diagram showing relationships between reduction peak onset potentials and onset potential widths when cyclic voltammetry measurements were performed in Example 1;

FIG. 5 is a diagram showing a typical cyclic voltammogram of an ionic liquid of a metal oxide;

FIG. 6 is a diagram showing reduction peak areas when cyclic voltammetry measurement were performed in Example 2;

FIG. 7 is a diagram showing oxidation peak areas when cyclic voltammetry measurements were performed in Example 2;

FIG. 8 is a diagram showing a CO₂ recovery amount when CO₂ adsorption is performed at a constant adsorption voltage and then CO₂ desorption is performed at a constant desorption voltage in Example 3 and Comparative Example 1;

FIG. 9 is a diagram showing a CO₂ recovery amount at each adsorption voltage in electrochemical cells of Example 3 and Comparative Example 1; and

FIG. 10 is a diagram showing a CO₂ recovery amount in each cycle in electrochemical cells of Example 4 and Comparative Example 2.

### DETAILED DESCRIPTION

When an organic material such as polyanthraquinone is used as a CO₂ adsorbent in an electrochemical cell, a durability may decrease due to an organic compound being eluted from the electrochemical cell.

On the other hand, when a carbon material is used as a CO₂ adsorbent in an electrochemical cell, an oxidation-reduction potential required for adsorption and desorption of CO₂ may become large. As a result, there is a possibility that the amount of electrical energy consumed during CO₂ recovery will increase.

An electrochemical cell according to an aspect of the present disclosure includes a working electrode and a counter electrode, and the working electrode includes a CO₂ adsorbent. The electrochemical cell is configured such that, when a voltage is applied between the working electrode and the counter electrode, electrons are supplied from the counter electrode to the working electrode, and the CO₂ adsorbent bonds with CO₂ contained in a CO containing gas in association with the electrons being supplied to the working electrode. The CO₂ adsorbent contains a transition metal oxide represented by a general formula MₓO_{y}, where M is a transition metal, x is within a range of 1≤x≤3, and y is within a range of 1≤y≤5, excluding a combination of x=1 and y=2.

According to this configuration, by using a substance containing the transition metal oxide represented by MₓO_{y} as the CO₂ adsorbent, it is possible to reduce a potential width, which is a difference between an adsorption potential and a desorption potential of CO₂. Thus, it becomes possible to reduce an input power required for CO₂ adsorption and desorption, and to reduce an electrical energy required for CO₂ recovery. Furthermore, since a reduction potential, which is the adsorption potential of CO₂, can be lowered, a side reaction that generates active oxygen can be restricted. Therefore, it becomes possible to enhance durability.

A carbon dioxide recovery system according to another aspect of the present disclosure is for separating CO₂ from a CO₂ containing gas by electrochemical reactions, and the carbon dioxide recovery system includes an electrochemical cell. The electrochemical cell includes a working electrode and a counter electrode, and the working electrode includes a CO₂ adsorbent. The CO₂ adsorbent contains a transition metal oxide represented by a general formula MₓO_{y}, where M is a transition metal, x is in a range of 1≤x≤3, and y is in a range of 1≤y≤5, excluding a combination of x=1 and y=2. The electrochemical cell is configured such that, when a first voltage is applied between the working electrode and the counter electrode, electrons are supplied from the counter electrode to the working electrode, causing the CO₂ adsorbent to adsorb CO₂ contained in the CO₂ containing gas, and, when a second voltage is applied between the working electrode and the counter electrode, electrons are supplied from the working electrode to the counter electrode, causing CO₂ to be desorbed from the CO₂ adsorbent.

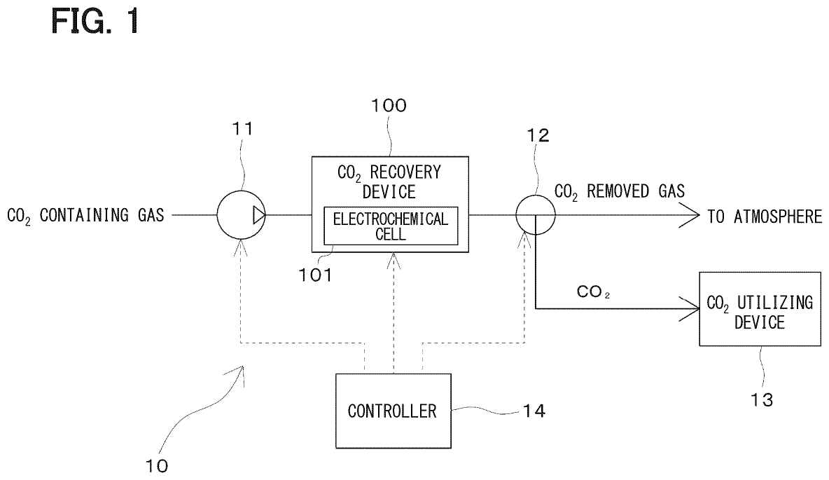

Hereinafter, an embodiment of the present disclosure will be described with reference to the drawings. As shown in FIG. 1, a carbon dioxide recovery system 10 of the present embodiment includes a compressor 11, a carbon dioxide recovery device 100, a flow path switching valve 12, a carbon dioxide utilizing device 13, and a controller 14.

The compressor 11 pumps a CO₂ containing gas to the carbon dioxide recovery device 100. The CO₂ containing gas is a mixed gas that contains CO₂ and a gas other than CO₂. As the CO₂ containing gas, for example, air can be used.

The carbon dioxide recovery device 100 is a device that separates and recovers CO₂ from the CO₂ containing gas. The carbon dioxide recovery device 100 discharges a CO₂ removed gas that is gas after CO₂ is recovered from the CO₂ containing gas, or CO₂ recovered from the CO₂ containing gas. The configuration of the carbon dioxide recovery device 100 will be described in detail later.

The flow path switching valve 12 is a three-way valve that switches a flow path of exhaust gas from the carbon dioxide recovery device 100. When the CO₂ removed gas is discharged from the carbon dioxide recovery device 100, the flow path switching valve 12 switches the flow path of the exhaust gas toward the atmosphere. When CO₂ is discharged from the carbon dioxide recovery device 100, the flow path switching valve 12 switches the flow path of the exhaust gas toward the carbon dioxide utilizing device 13.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a flow path switching control of the flow path switching valve 12 and the like.

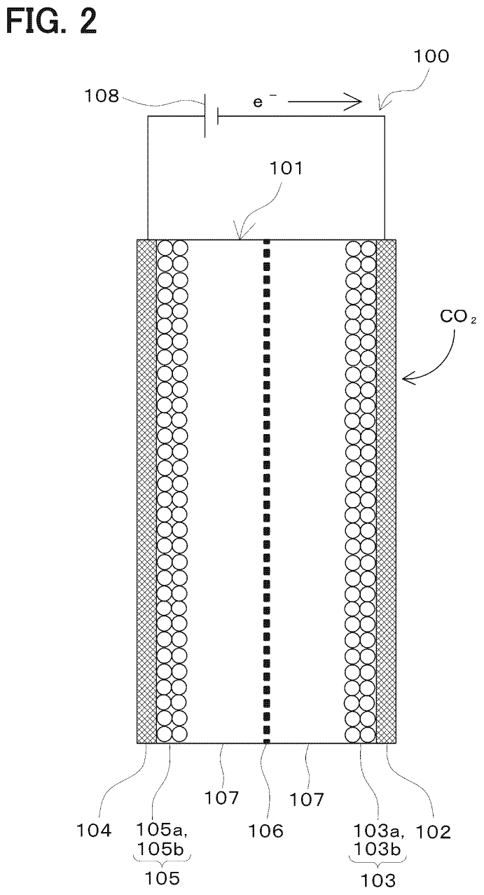

Next, the carbon dioxide recovery device 100 will be described with reference to FIG. 2. As shown in FIG. 2, the carbon dioxide recovery device 100 includes an electrochemical cell 101 configured to adsorb and desorb CO₂ by electrochemical reactions. The electrochemical cell 101 includes a working electrode current collector 102, a working electrode 103, a counter electrode current collector 104, a counter electrode 105, an insulating layer 106, and an electrolyte 107. The working electrode current collector 102, the working electrode 103, the counter electrode current collector 104, the counter electrode 105, and the insulating layer 106 are laminated.

The electrochemical cell 101 may be housed in a container (not shown). The container may define a gas inlet for introducing the CO₂ containing gas into the container and a gas outlet for discharging the CO₂ removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂ containing gas. The carbon dioxide recovery device 100 includes a power supply 108 that applies a predetermined voltage to the working electrode 103 and the counter electrode 105, and can change a potential difference between the working electrode 103 and the counter electrode 105. The working electrode 103 is a negative electrode, and the counter electrode 105 is a positive electrode.

The electrochemical cell 101 can be switched between a CO₂ recovery mode in which CO₂ is recovered at the working electrode 103 and a CO₂ discharge mode in which CO₂ is discharged from the working electrode 103 by changing the potential difference between the working electrode 103 and the counter electrode 105. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 103 and the counter electrode 105, and electrons flows from the counter electrode 105 to the working electrode 103. At the first voltage V1, the counter electrode potential is greater than the working electrode potential. The first voltage V1 may fall within a range from 0.5 to 2.0 V.

In the CO₂ discharge mode, a second voltage V2 is applied between the working electrode 103 and the counter electrode 105, and electrons flows from the working electrode 103 to the counter electrode 105. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

The working electrode current collector 102 is a porous conductive material having pores through which the CO₂ containing gas containing CO₂ can pass. As the working electrode current collector 102, for example, a carbonaceous material or a metal material can be used. The carbonaceous material constituting the working electrode current collector 102 may be, for example, carbon paper, carbon cloth, non-woven carbon mat, porous gas diffusion layer (GDL) and the like. The metal material constituting the working electrode current collector 102 may be, for example, a structure in which a metal such as aluminum (AI), nickel (Ni), stainless steel (SUS), or the like is formed into a mesh shape.

The working electrode 103 includes a working electrode substrate 103a, which is an electrode substrate, and a CO₂ adsorbent 103b. The working electrode substrate 103a is a conductive material that holds the CO₂ adsorbent 103b. As the working electrode substrate 103a, for example, a carbon sheet can be used. The CO₂ adsorbent 103b is an active material that gives and receives electrons by an oxidation-reduction reaction. The CO₂ adsorbent 103b adsorbs CO₂ by receiving electrons, and desorbs the adsorbed CO₂ by releasing electrons.

The CO₂ adsorbent 103b contains a transition metal oxide represented by the general formula MₓO_{y}. In MₓO_{y}, M is a transition metal, x is within a range of 1≤x≤3, and y is within a range of 1≤y≤5, excluding a combination of x=1 and y=2.

The transition metal oxide contained in the CO₂ adsorbent 103b may be, for example, M₂O, MO, M₃O₄, M₂O₃, MO₂, M₂O₅, or MO₃. As M₂O, for example, Cu₂O or Ag₂O can be used. As MO, for example, MnO, CuO, or ZnO can be used. As M₃O₄, for example, Fe₃O₄ or Co₃O₄ can be used. As M₂O₃, for example, Fe₂O₃ or Cr₂O₃ can be used. As M₂O₅, for example, V₂O₅ or Ta₂O₅ can be used. As MO₃, for example, MoO₃ or ReO₃ can be used.

In the present embodiment, as an example, at least one selected from a group consisting of Cu₂O, CuO, MoO₃, SnO₂, FeO, MnO, CoO, and Ag₂O is used as the transition metal oxide contained in the CO₂ adsorbent 103b.

The CO₂ adsorbent 103b may contain a composite oxide. The composite oxide contains the above-described transition metal oxide MₓO_{y} as a primary phase, and contains an oxide of the transition metal element M having a valence different from that of the above-described transition metal oxide MₓO_{y} as a secondary phase. As an example, in the present embodiment, the CO₂ adsorbent 103b is composed of composite oxide particles that contain Cu₂O as a primary phase and at least one of CuO and Cu as a secondary phase. A ratio of the primary phase to the secondary phase in the CO₂ adsorbent 103b is adjusted so that the primary phase is greater than the secondary phase. The CO₂ adsorbent 103b may also contain a doping material. The CO₂ adsorbent 103b will be described in detail in examples described later.

The working electrode 103 may further include a conductive additive and a binder. The conductive additive forms a conductive path to the CO₂ adsorbent 103b. For the conductive additive, for example, a carbon material such as carbon nanotube, carbon black, or graphene can be used. The binder may be a material that can hold the CO₂ adsorbent 103b on the working electrode substrate 103a and has conductivity. The binder may be a conductive resin such as an epoxy resin and a fluoropolymer, containing Ag or the like as a conductive filler. The fluoropolymer may be, for example, polytetrafluoroethylene (PTFE), or polyvinylidene fluoride (PVDF).

In the present embodiment, as an example, the working electrode substrate 103a is formed in a porous structure. The CO₂ adsorbent 103b, the conductive additive, and the binder are used in a mixed state. Specifically, a mixture of the CO₂ adsorbent 103b, a conductive additive, and a binder is formed, and the mixture is applied to and adhered to the working electrode substrate 103a. That is, the CO₂ adsorbent 103b, the conductive additive, and the binder are mixed and applied to the working electrode substrate 103a.

The counter electrode current collector 104 is made of a conductive material. The counter electrode current collector 104 may be made of the same material as the working electrode current collector 102 described above.

The counter electrode 105 includes a counter electrode substrate 105a and a counter electrode active material 105b. The counter electrode substrate 105a is made of a conductive material and holds the counter electrode active material 105b. As the counter electrode substrate 105a, for example, a carbon sheet can be used. The counter electrode active material 105b is an auxiliary electroactive species that exchanges electrons with the working electrode 103.

The counter electrode active material 105b is an active material that gives and receives electrons by an oxidation-reduction reaction. The counter electrode active material 105b may be, for example, a metal complex that can receive and release electrons by changing a valence of a metal ion. Examples of such a metal complex include cyclopentadienyl metal complexes such as ferrocene, nickelocene, and cobaltocene, porphyrin metal complexes, and the like. These metal complexes may be polymers or monomers. In the present embodiment, as an example, polyvinylferrocene is used as the counter electrode active material 105b. Ferrocene transfers electrons by changing the valence of Fe between divalent an trivalent.

The counter electrode 105 may further include a conductive additive and a binder. The conductive additive and the binder of the counter electrode 105 may be made of the same kinds of materials as the conductive additive and the binder of the working electrode 103 described above.

The insulating layer 106 is disposed between the working electrode 103 and the counter electrode 105, and separates the working electrode 103 and the counter electrode 105 from each other. The insulating layer 106 is an insulating ion permeable membrane that prevents physical contact between the working electrode 103 and the counter electrode 105 to restrict an electrical short circuit and that allows ions to permeate therethrough.

As the insulating layer 106, a separator or a gas layer such as air can be used. In the present embodiment, a porous separator is used as the insulating layer 106. As the material of the separator, a cellulose membrane, a polymer, a composite material of a polymer and a ceramic, or the like can be used.

An electrolyte 107 having ionic conductivity is provided between the working electrode 103 and the counter electrode 105. The electrolyte 107 is provided between the working electrode 103 and the counter electrode 105 via the insulating layer 106. The electrolyte 107 is provided to cover the working electrode 103, the counter electrode 105 and the insulating layer 106.

As an example, in the present embodiment, the electrolyte 107 is aprotic. The electrolyte 107 being aprotic is an electrolyte that does not donate protons (H⁺). Therefore, charges do not move to the electrolyte 107 due to proton generation, and the decrease in current efficiency during CO₂ adsorption can be restricted.

An ionic liquid can be used as the electrolyte 107 being aprotic. The ionic liquid is a salt of a liquid having non-volatility under normal temperature and pressure. When the ionic liquid is used as the electrolyte 107, the ionic liquid may be gelled to prevent elution of the ionic liquid from the electrochemical cell 101. As the ionic liquid having an aprotic property, [BMIM][TFSI], [TMPA][TFSI], [Pyrro][TFSI], [BMIM][Tfb], [EMIM][TFSI], or the like can be used. The electrolyte 107 will be described in detail in the examples described later.

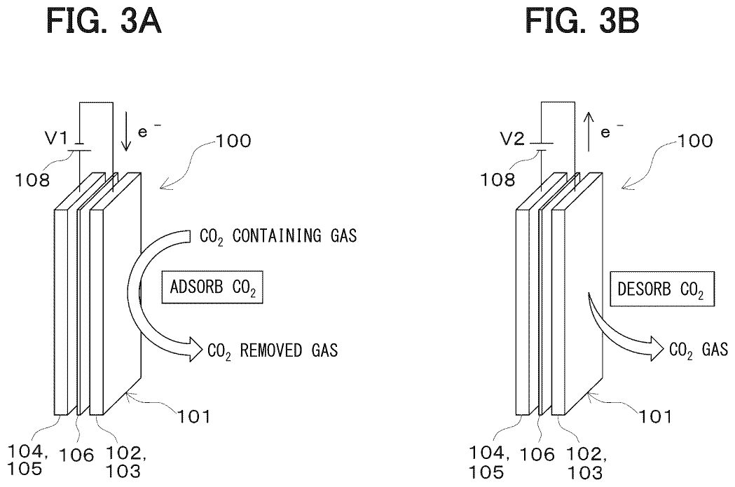

Next, an operation of the carbon dioxide recovery system 10 of the present embodiment will be described. The carbon dioxide recovery system 10 operates by alternately switching between the CO₂ recovery mode shown in FIG. 3A and the CO₂ discharge mode shown in FIG. 3B. The operation of the carbon dioxide recovery system 10 is controlled by the controller 14.

First, the CO₂ recovery mode will be described. In the CO₂ recovery mode, the compressor 11 operates to supply the CO₂ containing gas to the carbon dioxide recovery device 100. In the carbon dioxide recovery device 100, the voltage applied between the working electrode 103 and the counter electrode 105 is the first voltage V1. This makes it possible to simultaneously realize electron donation of the counter electrode 105 and electron attraction of the working electrode 103.

The counter electrode active material 105b of the counter electrode 105 discharges electrons to be oxidized, and the electrons are supplied from the counter electrode 105 to the working electrode 103. The CO₂ adsorbent 103b of the working electrode 103 receives electrons and adsorbs CO₂. In the present embodiment, CO₂ is adsorbed to the working electrode 103 in a state of being converted into at least one selected from a group consisting of CO_{2′}⁻, C₂O₄²⁻, and HCO₃⁻. Thus, the carbon dioxide recovery device 100 can recover CO₂ from the CO₂ containing gas.

After CO₂ is recovered from the CO₂ containing gas by the carbon dioxide recovery device 100, the CO₂ containing gas is discharged from the carbon dioxide recovery device 100 as the CO₂ removed gas containing no CO₂. The flow path switching valve 12 switches the flow path of exhaust gas toward the atmosphere, and the CO₂ removed gas from the carbon dioxide recovery device 100 is discharged to the atmosphere.

Next, the CO₂ discharge mode will be described. In the CO₂ discharge mode, the operation of the compressor 11 is stopped, and the supply of the CO₂ containing gas to the carbon dioxide recovery device 100 is stopped. In the carbon dioxide recovery device 100, the voltage applied between the working electrode 103 and the counter electrode 105 is set to the second voltage V2. As a result, electron donation of the CO₂ adsorbent 103b of the working electrode 103 and electron attraction of the counter electrode active material 105b of the counter electrode 105 can be realized at the same time.

The CO₂ adsorbent 103b desorbs and releases CO₂. CO_{2′-}, C₂O₄²⁻, and HCO₃⁻ adsorbed by the CO₂ adsorbent 103b are desorbed in a state of being converted into CO₂.

The CO₂ released from the CO₂ adsorbent 103b is discharged from the carbon dioxide recovery device 100. The flow path switching valve 12 switches the flow path of the exhaust gas toward the carbon dioxide utilizing device 13, and the CO₂ discharged from the carbon dioxide recovery device 100 is supplied to the carbon dioxide utilizing device 13.

### Example 1

The present inventors have evaluated the CO₂ adsorption and desorption performance of various metal oxides by a cyclic voltammetry method and conducted a comparative study. Specifically, Cu₂O, CuO, Bi₂O₃, CoO, FeO, In₂O₃, MnO, MoO₃, SnO₂, WO₃, ZrO₂ and Ag₂O were prepared as metal oxides, and C was also prepared as a comparative example. The prepared metal oxides and C were each made into a paste form, and the paste was applied to a glassy carbon electrode and dried to prepare a working electrode. Then, using each working electrode, five cycles of cyclic voltammetry measurements were performed under the following conditions.

An Ag/Ag+ electrode was used as a reference electrode, and Pt was used as a counter electrode.

The measurements were carried out in a solution of [TMPA][TFSI] (trimethylpropylammonium bis(trifluoromethanesulfonyl)imide), which is an ionic liquid.

CO₂ was used as a dissolved gas.

A sweep range was −1.2 V≤0 V, and a scan rate was 5 mV/s.

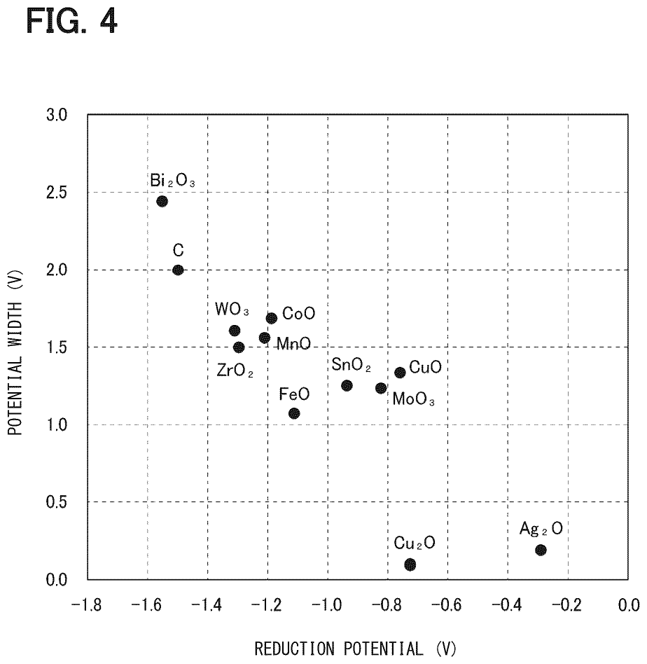

After the cyclic voltammetry measurements, reduction peak onset potentials and potential differences between oxidation peak onset potentials and the reduction peak onset potentials (hereinafter referred to as onset potential widths) were determined from the obtained cyclic voltammograms. The results are shown in FIG. 4.

The “peak onset potential” refers to the minimum external potential required to generate a current due to an oxidation or reduction reaction. The peak onset potentials are considered to be potentials derived from the sample, regardless of measurement or environmental factors.

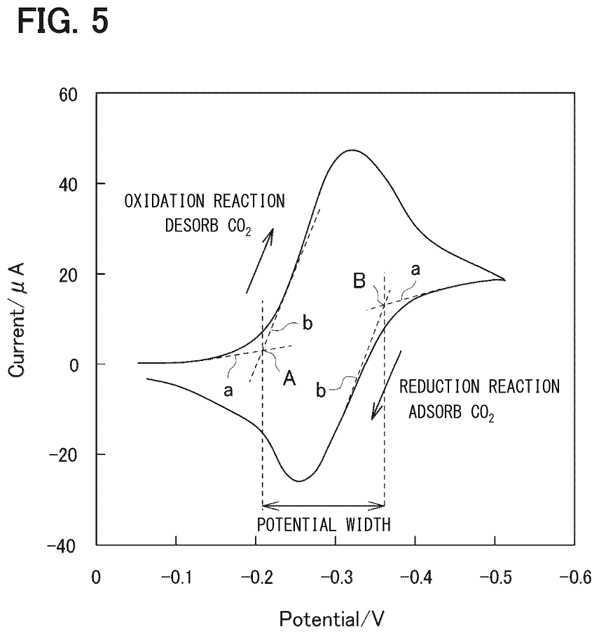

Specifically, as shown in FIG. 5, a tangent “a” to a straight line portion before an oxidation or reduction reaction occurs and a tangent “b” to a curve in a range where a reaction occurs and a current value increases are obtained. As shown by points A and B in FIG. 5, the value at the intersection of the broken line “a” and the broken line “b” is defined as the peak onset potential.

As is clear from FIG. 4, by using Cu₂O, CuO, MoO₃, SnO₂, FeO, MnO, CoO or Ag₂O as the working electrode of the electrochemical cell, it is possible to reduce the onset potential width and set the reduction potential to a low potential. In particular, by using Cu₂O or Ag₂O as the working electrode, the onset potential width can be made smaller and the reduction potential can be made even lower. According to the investigations of the present inventors, it is considered that the shorter the bond distance between the transition metal atom and the oxygen atom, the greater the effect of reducing the reduction potential while narrowing the onset potential width.

### Example 2

The present inventors investigated the ionic liquid to be used as the electrolyte 107 when Cu₂O is used as the CO₂ adsorbent 103b. The present inventors evaluated the CO₂ adsorption and desorption performances of various ionic liquids by the cyclic voltammetry method and conducted a comparative study. Specifically, first, the following eleven types of ionic liquids were prepared.
Ionic liquid A: 1-ethyl-3-methylimidazolium bis(trifluoromethanesulfonyl)imide
Ionic liquid B: 1-butyl-3-methylimidazolium bis(trifluoromethanesulfonyl)imide
Ionic liquid C: 1-butyl-2,3-dimethylimidazolium bis(trifluoromethanesulfonyl)imide
Ionic liquid D: 1-(2-methoxyethyl)-3-methylimidazolium bis(trifluoromethylsulfonyl)imide
Ionic liquid E: 1-ethyl-3-methylimidazolium acetate
Ionic liquid F: 1-butyl-3-methylimidazolium acetate
Ionic liquid G: 1-butyl-3-methylimidazolium methylsulfate
Ionic liquid H: Trimethylpropylammonium bis(trifluoromethanesulfonyl)imide
Ionic liquid I: 1-butyl-1-methylpyrrolidinium bis(trifluoromethanesulfonyl)imide
Ionic liquid J: 1-methoxyethyl-3-methylimidazolium bis(trifluoromethylsulfonyl)imide
Ionic liquid K: 1-butyl-3-methylimidazolium 1-2-4 triazole

Next, five cycles of cyclic voltammetry measurements were performed under the following conditions using each of the prepared ionic liquids A to K as an electrolyte.

A working electrode was prepared by applying Cu₂O in a paste form onto a glassy carbon electrode and drying it. An Ag/Ag+ electrode was used as a reference electrode, and Pt was used as a counter electrode.

CO₂ and air were used as dissolved gases.

A sweep range was −1.2 V≤0 V, and a scan rate was 5 mV/s.

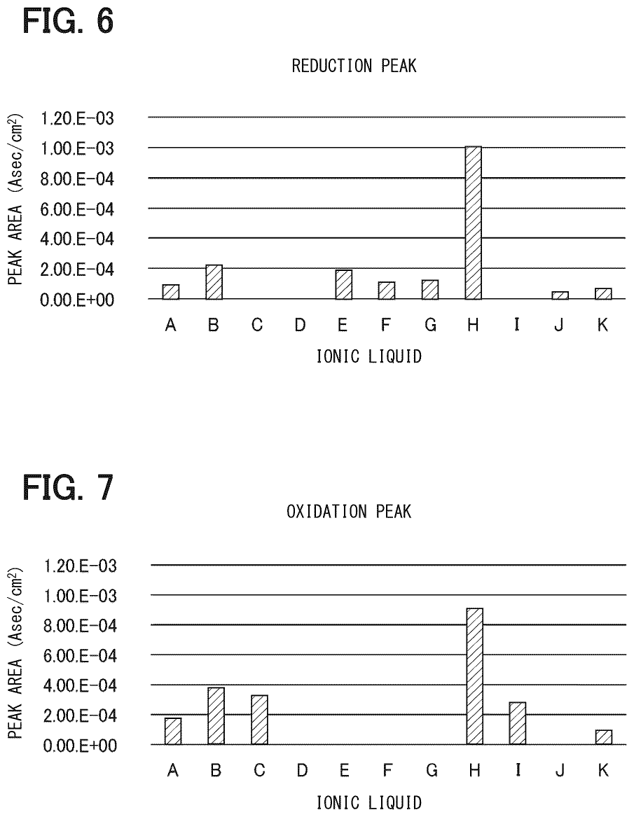

After the cyclic voltammetry measurements, reduction peak areas and oxidation peak areas in the obtained cyclic voltammograms were determined. The results are shown in FIG. 6 and FIG. 7. FIG. 6 shows the reduction peak areas when the ionic liquids A to K were used as the electrolyte, and FIG. 7 shows the oxidation peak areas when the ionic liquids A to K were used as the electrolyte. The larger the reduction peak area in the cyclic voltammogram, the higher the CO₂ adsorption performance. The larger the oxidation peak area in the cyclic voltammogram, the higher the CO₂ desorption performance.

As shown in FIG. 6 and FIG. 7, by using the ionic liquids A to C and the ionic liquid H as the electrolyte, it is possible to improve both the CO₂ adsorption performance and the CO₂ desorption performance. In particular, the use of the ionic liquid H can significantly improve both the CO₂ adsorption performance and the CO₂ desorption performance. For this reason, it is more desirable to use the ionic liquid H as the electrolyte.

### Example 3

The present inventors investigated the CO₂ adsorption and desorption efficiencies when Cu₂O is used as the CO₂ adsorbent 103b. Specifically, first, electrochemical cells 101 of Example 3 and Comparative Example 1 were prepared as follows.

In the electrochemical cell 101 of Example 3, as for the working electrode 103, a carbon sheet (GDL22BB manufactured by SGL Carbon Japan Co., Ltd.) was used as the working electrode substrate 103a, and a composite oxide of Cu₂O and C was used as the CO₂ adsorbent 103b. As for the counter electrode 105, a carbon sheet (H-060 manufactured by Toray Industries, Inc.) was used as the counter electrode substrate 105a, carbon nanotube was used as the conductive additive, and polyvinylferrocene (manufactured by NARD Institute) was used as the counter electrode active material 105b. A separator (manufactured by Whatman International Ltd.) was used as the insulating layer 106. [TMPA][TFSI] was used as the electrolyte 107.

The electrochemical cell 101 of Comparative Example 1 was similar to the electrochemical cell 101 of Example 3, except that the CO₂ adsorbent 103b was omitted.

Next, the adsorption and desorption efficiencies were measured when CO₂ adsorption and desorption were performed using the electrochemical cells 101 of Example 3 and Comparative Example 1.

The adsorption and desorption efficiencies were measured according to the following procedure. The electrochemical cell 101 to be measured was placed in a housing, and the inside of the housing was purged with a mixed gas of O₂ and N₂, after which a mixed gas of CO₂ and O₂ was introduced. Thereafter, the housing was sealed and the CO₂ desorption efficiency was measured.

In the measurement of the CO₂ desorption efficiency, a constant voltage was applied to the electrochemical cell 101 to perform adsorption and desorption of CO₂. At that time, the CO₂ recovery amount by the electrochemical cell 101 was measured by measuring the CO₂ recovery amount in the housing with a CO₂ sensor. In the present disclosure, the CO₂ recovery amount in the housing accommodating the electrochemical cell 101 is referred to as “the amount of CO₂ in the housing”.

When CO₂ adsorption by the electrochemical cell 101 is performed in the housing, the amount of CO₂ in the housing decreases. When CO₂ desorption by the electrochemical cell 101 is performed in the housing, the amount of CO₂ in the housing increases. Therefore, the decrease amount of the CO₂ amount in the housing corresponds to the CO₂ adsorption amount of the electrochemical cell 101, and the increase amount of the CO₂ amount in the housing corresponds to the CO₂ desorption amount of the electrochemical cell 101.

The CO₂ recovery amount is the amount of CO₂ adsorbed in the electrochemical cell 101. The decrease amount of the CO₂ amount in the housing corresponds to the increase amount of the CO₂ recovery amount, and the increase amount of the CO₂ amount in the housing corresponds to the decrease amount of the CO₂ recovery amount.

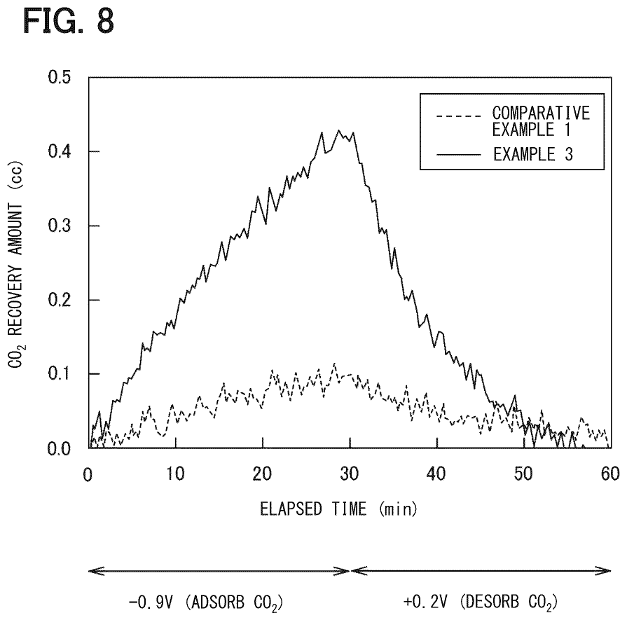

Next, the results of measuring the adsorption and desorption efficiencies of the electrochemical cells 101 of Example 3 and Comparative Example 1 will be described. FIG. 8 shows the CO₂ recovery amounts of the electrochemical cells 101 of Example 3 and Comparative Example 1 when CO₂ adsorption was performed at a constant adsorption voltage and then CO₂ desorption was performed at a constant desorption voltage. The adsorption voltage was −0.9 V, the desorption voltage was +0.2 V, and the adsorption time and the desorption time were each 30 minutes.

As shown in FIG. 8, when CO₂ adsorption was performed at a constant adsorption voltage (−0.9 V), the CO₂ recovery amount increased significantly in Example 3, whereas the increase in the CO₂ recovery amount was gradual in Comparative Example 1. In other words, in Example 3, the CO₂ inside the housing was efficiently adsorbed, and the CO₂ recovery amount increased significantly, whereas in Comparative Example 1, the CO₂ inside the housing could not be sufficiently adsorbed, and the increase in the CO₂ recovery amount was gradual.

Next, when CO₂ desorption was performed at a constant desorption voltage (+0.2 V), the CO₂ recovery amount decreased significantly in Example 3, whereas the decrease in the CO₂ recovery amount was gradual in Comparative Example 1. In other words, it is considered that in Example 3, the adsorbed CO₂ was efficiently desorbed, and the CO₂ recovery amount was significantly reduced. In contrast, it is considered that in Comparative Example 1, since the adsorption amount of CO₂ was small to begin with, even if the adsorbed CO₂ was desorbed, the decrease in the CO₂ recovery amount was gradual.

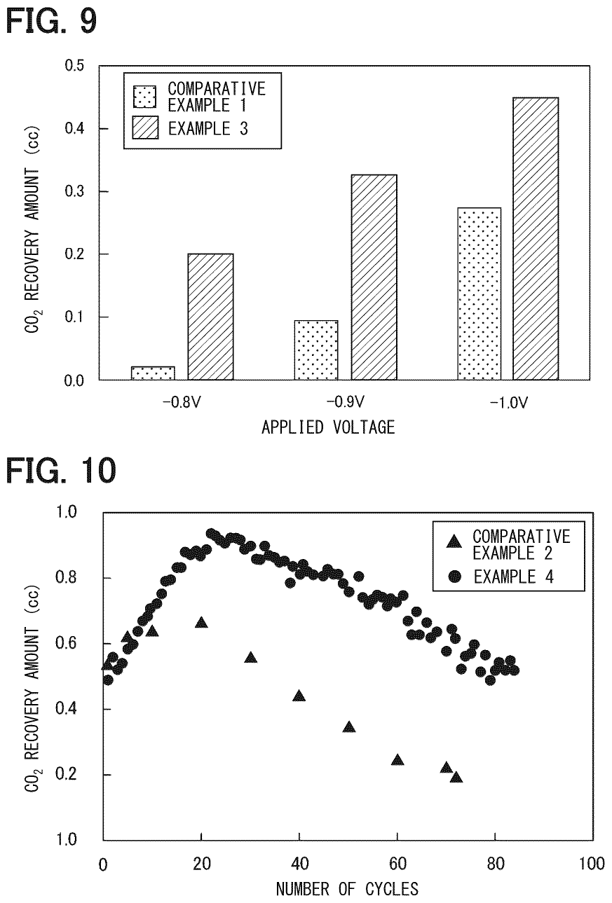

Next, the results of measuring the adsorption amounts relative to the adsorption voltages of the electrochemical cells 101 of Example 3 and Comparative Example 1 will be described. FIG. 9 shows the CO₂ recovery amounts when CO₂ adsorption was performed at adsorption voltages of −0.8V, −0.9V, and −1.0V for the electrochemical cells 101 of Example 3 and Comparative Example 1. The adsorption time was 30 minutes.

As shown in FIG. 9, in Comparative Example 1, the CO₂ recovery amount significantly decreased as the adsorption potential decreased, whereas in Example 3, the decrease in the CO₂ recovery amount was gradual even when the adsorption potential was low. That is, in Example 3, CO₂ can be recovered even if the adsorption potential is low. In other words, in Example 3, CO₂ can be recovered with low energy consumption.

### Example 4

The present inventors investigated the durability of the electrochemical cell 101 when Cu₂O is used as the CO₂ adsorbent 103b. Specifically, first, electrochemical cells 101 of Example 4 and Comparative Example 2 were prepared as follows.

In the electrochemical cell 101 of Example 4, as for the working electrode 103, carbon sheet (H-060 manufactured by Toray Industries, Inc.) was used as the working electrode substrate 103a, and a composite oxide of Cu₂O and C was used as the CO₂ adsorbent 103b. As for the counter electrode 105, a carbon sheet (H-060 manufactured by Toray Industries, Inc.) was used as the counter electrode substrate 105a, carbon nanotube was used as the conductive additive, and polyvinylferrocene (manufactured by NARD Institute) was used as the counter electrode active material 105b. A separator (manufactured by Whatman International Ltd.) was used as the insulating layer 106. [TMPA][TFSI] was used as the electrolyte 107.

The electrochemical cell 101 of Comparative Example 2 is similar to the electrochemical cell 101 of Example 4, except that the CO₂ adsorbent 103b of the working electrode 103 was omitted.

Next, the measurements of the CO₂ adsorption and desorption efficiencies were repeatedly carried out in the same manner as in Example 3. Here, one cycle is defined as a process in which CO₂ adsorption is performed at a constant adsorption voltage in the electrochemical cell 101 and then CO₂ desorption is performed at a constant desorption voltage.

FIG. 10 shows the CO₂ recovery amount in each cycle when the CO₂ adsorption and desorption efficiencies were measured for the electrochemical cells 101 of Example 4 and Comparative Example 2 over multiple cycles. In each cycle, the adsorption voltage was −0.9 V, the desorption voltage was +0.2 V, and the adsorption time and the desorption time were each 30 minutes.

As shown in FIG. 10, in both Example 4 and Comparative Example 2, the CO₂ recovery amount in each cycle gradually increased with an increase in the number of cycles, and the CO₂ recovery amount reached a maximum at around 20 cycles. After that, the CO₂ recovery amount for each cycle gradually decreased with increasing the number of cycles.

In the measurements of the CO₂ adsorption and desorption efficiencies, the CO₂ recovery amount in the first cycle is defined as an initial value, and the CO₂ recovery amount in the cycle in which the CO₂ recovery amount is maximum is defined as a maximum value.

In the electrochemical cell 101 of Comparative Example 2, the CO₂ recovery amount reached a maximum around the 20th cycle, and then the CO₂ recovery amount significantly decreased with increase in the number of cycles. After the 40th cycle, the CO₂ recovery amount decreased compared to the initial value. Specifically, the CO₂ recovery amount in the 72nd cycle was 36.2% of the initial value and 28.8% of the maximum value.

On the other hand, in the electrochemical cell 101 of Example 4, the CO₂ recovery amount reached a maximum around the 20th cycle, and then decreased more gradually than in Comparative Example 2 with increase in the number of cycles. Even after the 80th cycle, the CO₂ recovery amount did not decrease compared to the initial value. Specifically, the CO₂ recovery amount in the 72nd cycle was 124.8% of the initial value and 68.6% of the maximum value. Therefore, it can be said that the electrochemical cell 101 of Example 4 improved durability compared to the electrochemical cell 101 of Comparative Example 2.

In the present embodiment described above, a substance containing the transition metal oxide represented by the general formula MₓO_{y} is used as the CO₂ adsorbent 103b of the working electrode 103. Here, M is a transition metal, x is within the range of 1≤x≤3, and y is within the range of 1≤y≤5, excluding the combination of x=1 and y=2. Therefore, the oxidation-reduction potential width in the electrochemical cell 101 can be narrowed, while the reduction potential (that is, the adsorption potential of CO₂) can be lowered.

By narrowing the oxidation-reduction potential width, the difference between the adsorption potential and the desorption potential of CO₂ becomes smaller, so that the input power required for adsorption and desorption of CO₂ can be reduced. Therefore, it is possible to reduce the electrical energy required for CO₂ recovery.

When the reduction potential in the electrochemical cell 101 becomes higher, the possibility of active oxygen (O2′⁻) being generated by side reactions increases. In contrast, in the electrochemical cell 101 of the present embodiment, the reduction potential can be lowered as described above, and therefore side reactions that generate active oxygen can be restricted. This makes it possible to improve durability.

In the present embodiment, the aprotic ionic liquid is used as the electrolyte 107. Since the aprotic ionic liquid does not contain small ions such as lithium ions and sodium ions, the interaction between CO_{2′}⁻, C₂O₄²⁻, and HCO₃⁻ adsorbed to the working electrode 103 and cations contained in the ionic liquid can be reduced. As a result, the desorption power of CO₂ can be reduced, and CO₂ can be desorbed with low energy.

### OTHER EMBODIMENTS

The present disclosure is not limited to the embodiment described hereinabove, but may be modified in various ways as hereinbelow without departing from the gist of the present disclosure. For example, the CO₂ containing gas is not limited to the air, but may be any gas that contains CO₂, such as exhaust gas from an internal combustion engine.

What is claimed is:

1. An electrochemical cell comprising a working electrode that includes a CO₂ adsorbent and a counter electrode, wherein
the electrochemical cell is configured such that, when a voltage is applied between the working electrode and the counter electrode, electrons are supplied from the counter electrode to the working electrode, and the CO₂ adsorbent bonds with CO₂ contained in a CO containing gas in association with the electrons being supplied to the working electrode, and
the CO₂ adsorbent contains a transition metal oxide represented by a general formula MₓO_{y}, where M is a transition metal, x is within a range of 1≤x≤3, and y is within a range of 1≤y≤5, excluding a combination of x=1 and y=2.

2. The electrochemical cell according to claim 1, wherein
the CO₂ adsorbent contains a composite oxide, and
the composite oxide contains the transition metal oxide MₓO_{y} as a primary phase, and contains an oxide of the transition metal M having a valence different from the transition metal M in the transition metal oxide MₓO_{y} as a secondary phase.

3. The electrochemical cell according to claim 1, wherein
the CO₂ adsorbent contains at least one selected from a group consisting of Cu₂O, CuO, MoO₃, SnO₂, FeO, MnO, CoO, and Ag₂O.

4. The electrochemical cell according to claim 1, wherein
the CO₂ adsorbent contains composite oxide particles, and
the composite oxide particles contain Cu₂O as a primary phase and contain at least one of CuO and Cu as a secondary phase.

5. The electrochemical cell according to claim 1, wherein
the working electrode includes an electrode substrate that is porous, the CO₂ adsorbent, a conductive additive, and a binder, and
the CO₂ adsorbent, the conductive additive, and the binder are mixed and applied to the electrode substrate.

6. The electrochemical cell according to claim 1, further comprising
an electrolyte that covers the working electrode and the counter electrode, and is an ionic liquid.

7. The electrochemical cell according to claim 6, wherein
the ionic liquid is aprotic.

8. A carbon dioxide recovery system for separating CO₂ from a CO₂ containing gas by electrochemical reactions, the carbon dioxide recovery system comprising an electrochemical cell, the electrochemical cell including a working electrode that includes a CO₂ adsorbent and a counter electrode, wherein
the CO₂ adsorbent contains a transition metal oxide represented by a general formula MₓO_{y}, where M is a transition metal, x is in a range of 1≤x≤3, and y is in a range of 1≤y≤5, excluding a combination of x=1 and y=2, and
the electrochemical cell is configured such that, when a first voltage is applied between the working electrode and the counter electrode, electrons are supplied from the counter electrode to the working electrode, causing the CO₂ adsorbent to adsorb CO₂ contained in the CO₂ containing gas, and, when a second voltage is applied between the working electrode and the counter electrode, electrons are supplied from the working electrode to the counter electrode, causing CO₂ to be desorbed from the CO₂ adsorbent.
